(19) United States
(12) Patent Application Publication
(10) Pub. No.: US 2002/0044161 A1
(43) Pub. Date: Apr. 18, 2002

(54) Multi-window display system and method for displaying video data and storage medium

(76) Inventor: Kazuaki Sugai, Kanagawa (JP)

Correspondence Address: ROSSI & ASSOCIATES, P.O. Box 826, Ashburn, VA, 20146-0826, US

(21) Appl. No.: 09/863,071

(22) Filed: May 22, 2001

(30) Foreign Application Priority Data
May 22, 2000 (JP) 2000-150413
May 29, 2000 (JP) 2000-158362

(51) Int. Cl. G06F 3/14

(52) U.S. Cl. 345/781

(57) ABSTRACT

There is provided a multi-window display system that realizes simplified operation of window displays. Digital data selected more recently is displayed in a main screen window display section, and a plurality of subsidiary screen window display sections are displayed at progressively smaller sizes relative to the main screen window display section, which is displayed at the maximum size. Moreover, when a window display section is selected and a direction of movement is indicated, the selected window display section is moved in the indicated direction and displayed at an enlarged size. The size of the operation panel window display section corresponding to the selected one of the window display section is changed in accordance with the changing of the size of the selected one of the window display section. When one of the window display section is selected, the operation panel window display section corresponding to the window display section other than the one of the window display section selected by the selecting section is displayed semi-transparently.

### BACKGROUND OF THE INVENTION

1. Field of the Invention

The present invention relates to a multi-window display system that displays multiple windows on a display screen, and in particular to a multi-window display system that displays a plurality of pieces of digital video data in a plurality of windows.

2. Related Background Art

Conventional multi-window display systems in which video window displays for a plurality of pieces of digital video data and operation panel window displays for each of the pieces of video data are displayed include the following:

(1) Systems in which all of a plurality of subsidiary screen video window displays—i.e. the video window displays other than a main screen video window display, which is displayed at maximum size—are displayed at the same size.

(2) Systems in which the sizes of the main screen video window display and the subsidiary screen video window displays are not linked to one another but rather vary in an unsystematic way, the result being that it is necessary to adjust each of the sizes separately.

(3) Systems in which a plurality of video window displays are displayed, but these video window displays are not organized and thus overlap with one another in places.

Moreover, conventional multi-window display systems that display a plurality of pieces of digital video data provide the viewer with an environment in which viewing is easy, in which if, for example, the video window display for a particular piece of digital video data is selected using a pointer and an ‘enlarge display’ instruction is given, then the selected video window display is enlarged to fill the entire screen or to a suitable size

Moreover, with conventional multi-window display systems that display digital video data, video window display section(s) for displaying the digital video data and operation panel display section(s) corresponding to the video window display section(s) are displayed. As a result, when a plurality of video window display sections are displayed, a plurality of operation panel display sections—one corresponding to each of the video window display sections—are displayed.

However, with such conventional multi-window display systems:

(1) The plurality of subsidiary screen video window displays are not displayed at progressively smaller window sizes relative to the main screen video window display, which is displayed at maximum size;

(2) The sizes of the main screen video window display and the subsidiary screen video window displays are not linked to one another;

(3) A plurality of video window displays may be displayed overlapping one another.

The history of changes in the order of display precedence of the video window displays for a plurality of digital video sources is thus unknown, and making adjustments so that this history is known tends to result in operation becoming complicated.

Moreover, with the above conventional multi-window display systems, the enlargement and contraction of a video window display and the enlargement and contraction of the corresponding operation panel window display are not synchronized. For example, when the video window display for a particular piece of digital video data is selected using the pointer and an ‘enlarge display’ instruction is given, enlargement of the corresponding operation panel window display and enlargement of the operating buttons and an increase in the number of operating buttons do not accompany this, but rather these adjustments must be carried out separately.

Moreover, after controlling and viewing of a particular piece of digital video data have been completed and the user wishes to enlarge the video window display for another piece of digital video data, when the video window display for the particular piece of digital video data is contracted to a state where operation and viewing are hardly carried out, the corresponding operation panel window display is not automatically contracted at the same time, but rather this adjustment must be carried out separately.

With such multi-window display systems, when the user's volition or wishes are reflected in the determination of the window layout, there is a tendency for operation to become complicated and the amount of work involved to increase if the level of freedom for the user's volition or wishes to be reflected is increased too much.

Moreover, if the operation is simplified and the amount of work involved is reduced, then there is a risk of the extent to which the user's volition is reflected dropping and it becoming impossible for the user to obtain a desired layout.

Furthermore, since a plurality of video window display sections and operation panel display sections corresponding to these video window display sections are displayed simultaneously on a single screen, the display may become complicated.

Moreover, after shifting his/her eyes from an operation panel display section using which he/she is carrying out operations to another display section, when the user returns to the operation panel display section to carry out operations once again, because there are a plurality of displays on the screen, it tends to be difficult to refocus on the operation panel display section in question.

### SUMMARY OF THE INVENTION

With the foregoing in view, it is an object of the present invention to provide a multi-window display system and a multi-window display method which are capable of realizing simplified operation of window displays, and a storage medium storing a program for implementing the method.

Moreover, with the foregoing in view, it is another object of the present invention to provide a multi-window display system and a multi-window display method which are capable of providing an easy-to-view screen display while reflecting the user's wishes, and a storage medium storing a program for implementing the method.

To attain the above objects, in a first aspect of the present invention, there is provided a multi-window display system comprising a plurality of window display sections that each display data operation panel window display sections displaying operation panel windows that operate the window display sections, a selecting section that selects one of the window display sections, and a control section that is responsive to selection of one of the window display sections by the selecting section, changes sizes of the window display sections based on an order of selection by the selecting section.

Further, in the first aspect, there are also provided a multi-window display method comprising a first display step of displaying a plurality of pieces of data in a plurality of window display sections, a second display step of displaying operation panel windows for operating the window display sections in operation panel window display sections, a selection step of selecting one of the window display sections, and a control step of changing sizes of the window display sections based on an order of selection by the selecting section, in response to selection of one of the window display sections by the selection step, and a storage medium storing a program that is executable by a computer for implementing the multi-window display method.

In a preferred form of the first aspect, display positions and sizes of the vide window display sections and the operation panel display sections are determined such that the selected one of the window display sections does not overlap with any of the window display sections other than the selected one of the window display sections or any of the operation panel window display sections.

Preferably, a display position and size of the window display sections other than the selected one of the window display sections is determined based on a display position and size of the selected one of the window display sections.

Also preferably, an order of display precedence for and a history of selection of the window display sections may be stored.

To attain the above objects, in a second aspect of the present invention, there is provided a multi-window display system comprising a plurality of window display sections that each display data, a plurality of operation panel window display sections that display a plurality of operation panel windows having operating buttons for operating the window display sections, a selecting section that selects one of the window display sections, and a control section that changes a size of one of the operation panel window display sections corresponding to the selected one of the window display sections in accordance with a changing of a size of the selected one of the window display sections.

Further, to attain the above objects, in the second aspect, there are also provided a multi-window display method comprising a first display step of displaying a plurality of pieces of data in a plurality of window display sections, a second display step of displaying a plurality of operation panel windows having operating buttons for operating the window display sections in a plurality of operation panel window display sections, a selection step of selecting one of the window display sections, and a control step of changing a size of one of the operation panel window display sections corresponding to the selected one of the window display sections in accordance with a changing of a size of the selected one of the window display sections, and a storage medium storing a program that is executable by a computer for implementing the multi-window display method.

Preferably, the sizes of the operating buttons of the operation panel window display sections are changed in accordance with the changing of the size of the selected one of the window display sections.

Also preferably, the numbers of the operating buttons of the operation panel window display sections are changed in accordance with the changing of the size of the selected one of the window display sections.

Further preferably, the display positions and sizes of all of the window display sections and operation panel window display sections that are being displayed, are changed in accordance with the changing of the size of the selected one of the window display sections.

To attain the above objects, in a third aspect of the present invention, there is provided a multi-window display system comprising a plurality of window display sections that each display data, operation panel window display sections that display operation panel windows for operating the window display sections, a selecting section that selects one of the window display sections, a movement direction indicating section that indicates a direction of movement of the one of the window display sections selected by the selecting section, and a control section that is responsive to indication of the direction of movement of the selected one of the window display sections by the movement direction indicating section, for moving the selected one of the window display sections in the indicated direction of movement and displaying the selected one of the window display sections at an enlarged size.

Further, to attain the above objects, in the third aspect, there is also provided a multi-window display method comprising a first display step of displaying a plurality of pieces of data in a plurality of window display sections, a second display step of displaying operation panel windows for operating the window display sections in operation panel window display sections, a selecting step of selecting one of the window display sections, a movement direction indicating step of indicating a direction of movement of the selected one of the window display sections, and a control step of moving, in response to indication of the direction of movement of the selected one of the window display sections by the movement direction indicating section, the selected one of the window display sections in the indicated direction of movement and displaying the selected one of the window display sections at an enlarged size.

In a preferred form of the third aspect, when one of the window display sections has been selected by the selecting section, control is carried out such that at least one of the window display sections other than the selected one of the window display sections are displayed so as not to overlap with the selected one of the window display sections.

More preferably, when one of the window display sections has been selected, the selected one of the window display sections is displayed at an enlarged size.

Also preferably, when the one of the window display sections displayed at the enlarged size is moved in the indicated direction of movement, the one of the window display sections displayed at the enlarged size is displayed at maximum size.

Preferably, when the one of the window display sections displayed at the enlarged size is moved in the indicated direction of movement, the operation panel window display sections are displayed in a region not occupied by the window display sections.

To attain the above objects, in a fourth aspect of the present invention, there is provided a multi-window display system comprising a plurality of window display sections that each display data, operation panel window display sections that display a plurality of operation panels each corresponding to one of the window display sections, a selecting section that selects one of the window display sections or one of the operation panel window display sections, and a control section that is responsive to selection of one of the window display sections by the selecting section, for semi-transparently displaying at least one of the operation panel window display sections corresponding to at least one of the window display sections other than the one of the window display sections selected by the selecting section.

Further, to attain the above objects, in the fourth aspect, there is also provided a multi-window display method comprising a first display step of displaying a plurality of pieces of data in a plurality of window display sections, a second display step of displaying a plurality of operation panels each corresponding to one of the window display sections in operation panel window display sections, a selecting step of selecting one of the window display sections or one of the operation panel window display sections, and a control step of semi-transparently displaying, in response to selection of one of the window display sections by the selecting step, at least one of the operation panel window display sections corresponding to at least one of the window display sections other than the one of the window display sections selected by the selecting section.

Preferably, when another one of the operation panel window display sections has been selected following selection of the one of the operation panel window display sections, display of one of the operation panel window display sections corresponding to the another one of the window display sections is changed from semi-transparent display to non-transparent display.

Also preferably, when one of the operation panel window display sections has been selected, the selected one of the operation panel window display sections is non-transparently displayed.

The above and other objects, features and advantages of the present invention will become more apparent from the following detailed description taken in conjunction with the accompanying drawings.

### BRIEF DESCRIPTION OF THE DRAWINGS

FIG. 1 is a block diagram showing the constitution of a multi-window display system according to a first embodiment of the present invention;

FIG. 2 is a block diagram showing the constitution of a set top box 9 appearing in FIG. 1;

FIGS. 3A and 3B is a flow chart showing a multi-window display procedure for a high resolution large screen display device 1 appearing in FIG. 1;

FIG. 4 is a block diagram showing the constitution of a multi-window display system according to a second embodiment of the present invention;

FIG. 5 is a flow chart showing a processing procedure for enlarging an enlarged video window display section 30 appearing in FIG. 4;

FIG. 6 is a flow chart showing a processing procedure for contracting a contracted video window display section 31 and a contracted operation panel display section 34, both appearing in FIG. 4;

FIG. 7 is a block diagram showing the constitution of a multi-window display system according to a third embodiment of the present invention;

FIGS. 8A and 8B is a flow chart showing a multi-window display procedure for the high resolution large screen display device 1;

FIG. 9 is a block diagram showing the constitution of a multi-window display system according to a fourth embodiment of the present invention; and

FIGS. 10A and 10B a flow chart showing a multi-window display procedure for the high resolution large screen display device 1 when a selected video window display section 40 appearing in FIG. 9 has been selected using a pointer 23.

### DETAILED DESCRIPTION OF PREFERRED EMBODIMENTS

Embodiments of the present invention will now be described with reference to the drawings.

(First embodiment)

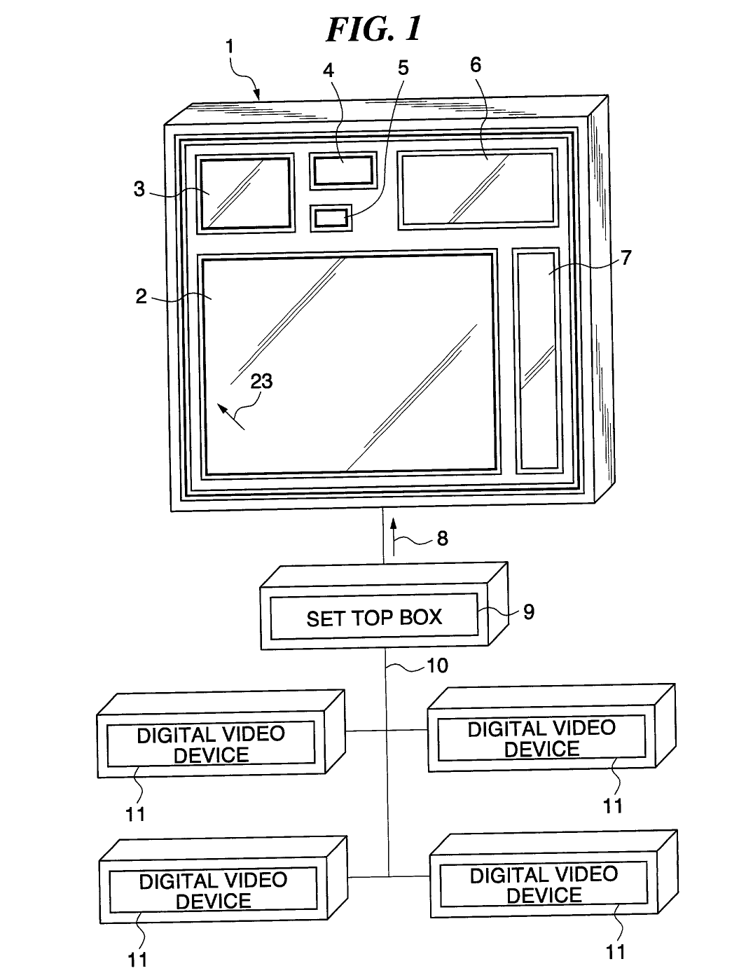

FIG. 1 is a block diagram showing the constitution of a multi-window display system according to a first embodiment of the present invention.

In FIG. 1, the multi-window display system is comprised of a plurality of digital video devices 11, a set top box 9, and a high resolution large screen display device 1 which is connected to the digital video devices 11 via the set top box 9 and which is capable of displaying video windows and operation panels for each of the digital video devices 11. The digital video devices 11 send compressed digital video data and operation panel information to the set top box 9 via a digital serial bus 10.

The high resolution large screen display device 1 is comprised of a main screen video window display section 2 in which digital video data selected using a pointer 23 is automatically expanded to the maximum display size and displayed, a subsidiary screen video window display section 3 which has a display area smaller than that of the main screen video window display section 2 and in which digital video data selected using the pointer 23 immediately before the digital video data currently displayed in the main screen video window display section 2 is displayed, a subsidiary screen video window display section 4 which similarly has a display area smaller than that of the subsidiary screen video window display section 3, a subsidiary screen video window display section 5 which has a display area smaller than that of the subsidiary screen video window display section 4, an operation panel window display section 6 in which is integrated the operation system for all of the digital video data for the subsidiary screen video window display sections 3 to 5, and an operation panel window display section 7 corresponding to only the digital video data for the main screen video window display section 2.

Here, in the operation panel window display section 7, instruction buttons for giving detailed control instructions are displayed so that the main screen video window display section 2 can be controlled in detail. In the operation panel window display section 6, on the other hand, instruction buttons for giving only a predetermined minimum necessary amount of control instructions for the subsidiary screen video window display sections 3 to 5 are displayed.

The set top box 9 composes the digital video data for displaying in the main screen video window display section 2 and the subsidiary screen video window display sections 3 to 5, and the operation panel display graphic data for displaying in the operation panel window display section 6 and the operation panel window display section 7, and then outputs the composed data to the high resolution large screen display device 1 as a picture signal 8.

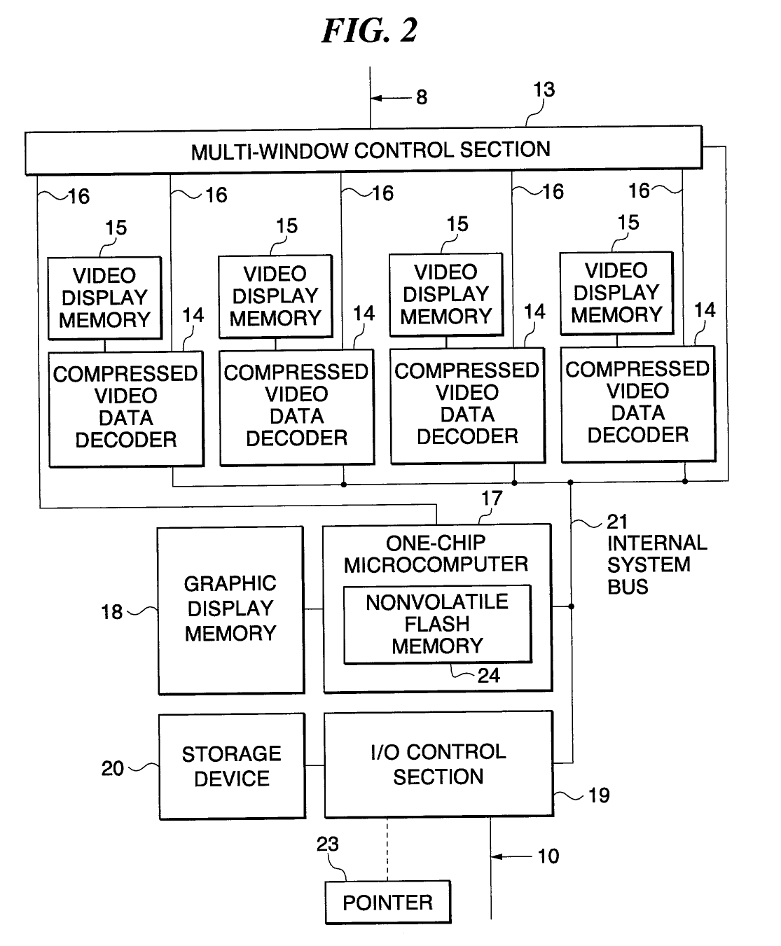

FIG. 2 is a block diagram showing the constitution of the set top box 9.

The set top box 9 has a multi-window control section 13 that composes the digital video data and the operation panel display graphic data. To the multi-window control section 13, compressed video data decoders 14, video display memories 15 and a one-chip microcomputer 17 are connected via internal video buses 16, and moreover the one-chip microcomputer 17 and an I/O control section 19 are connected via an internal system bus 21.

Furthermore, a graphic display memory 18 is connected to the one-chip microcomputer 17, and a storage device 20 is connected to the I/O control section 19.

The compressed video data decoders 14 convert compressed digital video data supplied from the I/O control section 19 via the one-chip microcomputer 17 into uncompressed digital video data. The video display memories 15 are used by the compressed video data decoders 14 as working areas, storing the uncompressed digital video data after this work has been completed.

The internal video buses 16 are used when sending the uncompressed digital video data and the operation panel display graphic data from the I/O control section 19 to the multi-window control section 13. The one-chip microcomputer 17 is provided with a graphics controller that controls the graphic display memory 18, a bus controller that controls the internal system bus 21, a CPU, a ROM, a RAM, a memory controller, a nonvolatile flash memory 24, and others. Note that it is not necessary for there to be a plurality of compressed video data decoders 14, but rather it is also possible to use a single signal processing processor having a high parallel processing capability, in which case only one video display memory 15 is used.

The graphic display memory 18 is used when forming the operation panel display graphic data (for example bit map data), and also temporarily stores the program executed by the one-chip microcomputer 17. The I/O control section 19 controls the digital serial bus 10, controls the internal system bus 21, and receives position information on the pointer 23.

The storage device 20 stores the program executed by the one-chip microcomputer 17 and stores the compressed digital video data. The internal system bus 21 is used for transferring the compressed digital video data, control data for the various devices and control commands. The pointer 23 is used for indicating various position information and window display sizes.

When the pointer 23 is moved, information on the relative movement from the position before the movement is transferred directly to the I/O control section 19. This relative movement information is also transferred to the one-chip microcomputer 17 via the internal system bus 21, and the one-chip microcomputer 17 forms an arrow in a position in the graphic display memory 18 corresponding to the appropriate position on the screen of the high resolution large screen display device 1.

This arrow is used for instructions for the main screen video window display section 2, the subsidiary screen video window display sections 3 to 5 and the operation panel window display sections 6 and 7. In the present embodiment, for the sake of simplicity, ‘arrow’ is used both to mean the position information on the screen after the processing by the one-chip microcomputer 17 has been completed and to mean the arrow graphics pattern.

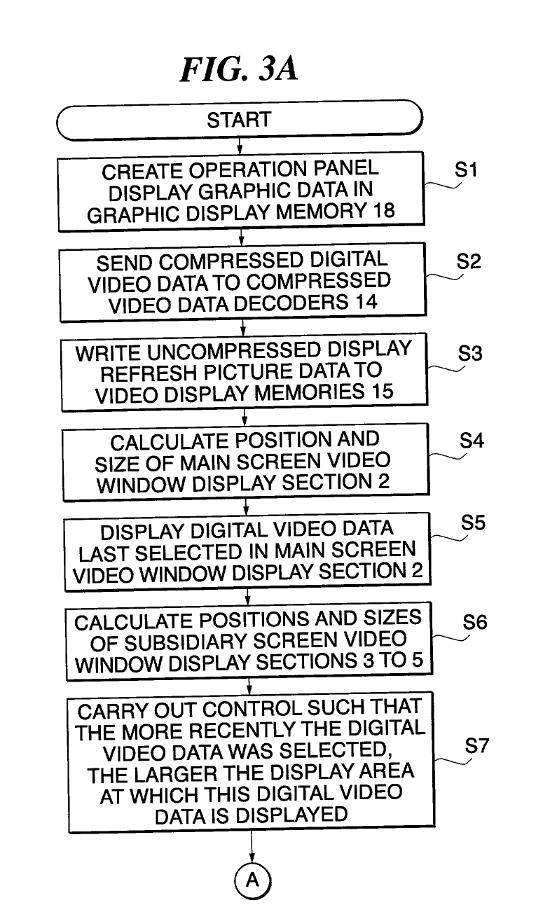

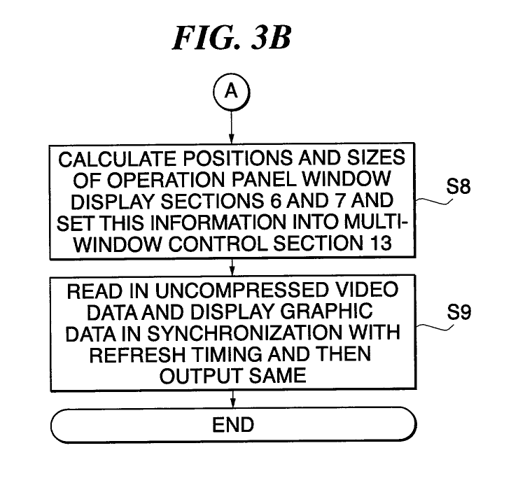

A description will now be given of a multi-window display method for the high resolution large screen display device 1, with reference to FIG. 3A and 3B.

First, operation panel information necessary for displaying the operation panel window display sections 6 and 7 is sent from the digital video devices 11 to the I/O control section 19 of the set top box 9 via the digital serial bus 10, and operation panel display graphic data corresponding to the necessary functions is created in the graphic display memory 18 by the one-chip microcomputer 17 (step S1).

The compressed digital video data necessary for the main screen video window display section 2 and the subsidiary screen video window display sections 3 to 5, is sent, like the operation panel information, from the digital video devices 11 to the I/O control section 19 of the set top box 9 via the digital serial bus 10, and is then sent from the I/O control section 19 to the compressed video data decoders 14 via the internal system bus 21 by the one-chip microcomputer 17 of the set top box 9 (step S2).

The compressed digital video data is temporarily written to the video display memories 15 in a still compressed state, and after expansion processing has been carried out by the compressed video data decoders 14, is then once again written to the video display memories 15, this time as uncompressed digital video data, namely display refresh picture data (step S3).

To make the main screen video window display section 2 selected by a decision operation using the pointer 23 the maximum display window size, the one-chip microcomputer 17 calculates the position and size of this main screen video window display section 2 (step S4).

Moreover, the one-chip microcomputer 17 saves selection history information for each of the video window displays and an order of display precedence in the nonvolatile flash memory 24, and decides the sizes of the video window displays by referring to this information.

Regarding the relative sizes of the main screen video window display section 2 and the subsidiary screen video window display sections 3 to 5, the digital video data last selected using the pointer 23 is automatically displayed in the main screen video window display section 2, which is the largest screen video window display section (step S5), and the positions and sizes of the subsidiary screen video window display sections 3 to 5 are calculated from the remaining display area of the high resolution large screen display device 1 so as not to overlap with the main screen video window display section 2 (step S6).

At this time, the digital video data selected using the pointer 23 immediately before the digital video data currently displayed in the main screen video window display section 2 is displayed in the subsidiary screen video window display section 3, the digital video data selected using the pointer 23 immediately before that is displayed in the subsidiary screen video window display section 4, and the digital video data selected using the pointer 23 immediately before that is displayed in the subsidiary screen video window display section 5, that is, control is carried out such that the more recently the digital video data was selected, the larger the display area at which this digital video data is displayed (step S7).

The above operation in which the digital video data that was displayed in one of the subsidiary screen video window display sections is displayed in another one of the subsidiary screen video window display sections one size smaller is continued in order, rather like a chain reaction, until the digital video data currently displayed in the main screen video window display section 2 becomes the size of the previously displayed subsidiary screen video window display section.

At the same time, the one-chip microcomputer 17 calculates the positions and sizes of the operation panel window display section 7 corresponding to the main screen video window display section 2 and the operation panel window display section 6 corresponding to the subsidiary screen video window display sections 3 to 5 from the remaining display area of the high resolution large screen display device 1 based on the position information stored in the nonvolatile flash memory 24, and sets information on these positions and sizes into the multi-window control section 13 via the internal system bus 21 (step S8).

The multi-window control section 13 reads in uncompressed video data and operation panel display graphic data from the video display memories 15 and the graphic display memory 18 in synchronization with the refresh timing of the display positions of the window displays on the screen of the high resolution large screen display device 1, and outputs this to the high resolution large screen display device 1 as a picture signal 8 (step S9).

As a result, the multi-window display system according to the present embodiment achieves multi-window display.

As described above, according to the present embodiment, the most recently selected digital video data is displayed in the main screen video window display section 2, which is displayed at the maximum size, subsidiary screen video window display sections 3 to 5 are displayed at progressively smaller sizes relative to the main screen video window display section 2, and the main screen video window display section 2 and the subsidiary screen video window display sections 3 to 5 are prevented from being displayed overlapping one another. As a result, there is no longer any need to manually adjust the sizes of the main screen video window display section 2 and the subsidiary screen video window display sections 3 to 5, and hence video window display operation can be simplified.

(Second embodiment)

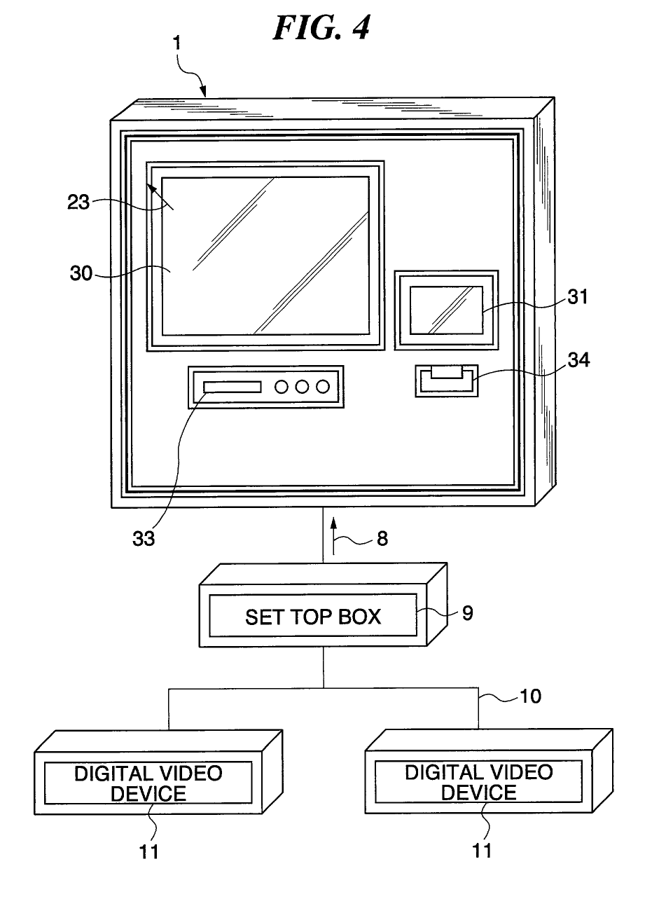

FIG. 4 is a block diagram showing the constitution of a multi-window display system according to a second embodiment of the present invention.

The multi-window display system according to the second embodiment of the present invention is the same as the multi-window display system of the above described first embodiment with the exception that the display contents of the high resolution large screen display device 1 differ. Corresponding component elements to those in the first embodiment are thus designated by the same reference numerals, and description of these component elements is omitted.

In FIG. 4, the following are displayed on the high resolution large screen display device 1: an enlarged video window display section 30 that is selected using the pointer 23 and displayed at an enlarged size, a contracted video window display section 31 that is either selected using the pointer 23 and displayed at a contracted size or else is automatically displayed at a contracted size when other digital video data is selected in the enlarged video window display section 30, an enlarged operation panel display section 33 that is automatically enlarged along with the enlarged video window display section 30, and a contracted operation panel display section 34 that is automatically contracted along with the contracted video window display section 31.

First, an explanation will be given of the case in which the enlarged video window display section 30 is enlarged using the pointer 23.

The enlargement is carried out by selecting an edge of the enlarged video window display section 30 using the pointer 23 and dragging this edge or border outwards. Hereinafter, this operation will be referred to as ‘dragging the window display border’.

The aspect ratio of the border during enlargement is determined from the shape of the window display border before the change as stored in the nonvolatile flash memory 24.

FIG. 4 shows a state in which the enlarged video window display section 30 has already been enlarged. When an instruction is given to enlarge the size of the enlarged video window display section 30 as described above by dragging the window display border using the pointer 23, the one-chip microcomputer 17 in the set top box 9 calculates the display position and size of the enlarged video window display section 30 on the high resolution large screen display device 1, referring to information on the previous position and shape of the window display border stored in the nonvolatile flash memory 24, calculates necessary parameters, and sets these parameters into the multi-window control section 13.

The multi-window control section 13 reads in digital video data from the video display memories 15 in synchronization with the refresh timing of the display position and size of the enlarged video window display section 30 on the high resolution large screen display device 1, and outputs this to the high resolution large screen display device 1 as a picture signal 8.

As a result of the above, enlargement of the enlarged video window display section 30 is achieved.

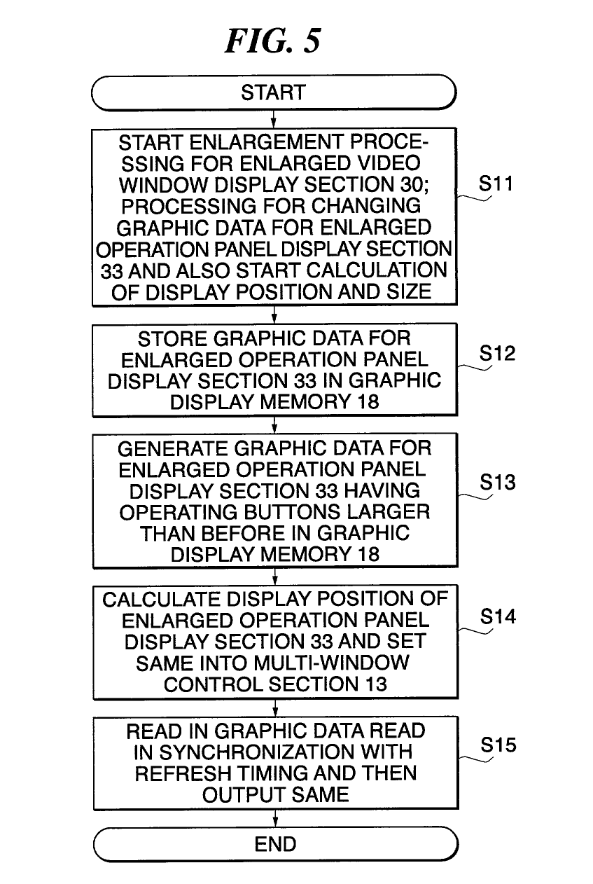

FIG. 5 is a flow chart showing a program for the case of enlarging the enlarged video window display section 30.

First, together with the enlargement processing for the enlarged video window display section 30, the one-chip microcomputer 17 starts the processing for changing the graphic data for the enlarged operation panel display section 33 and the calculation of the display position and size to be instructed to the multi-window control section 13, referring to the position information for the enlarged operation panel display section 33 before the change stored in the nonvolatile flash memory 24 (step S11).

The image of the enlarged operation panel display section 33 is graphic data, and hence this data is stored in the graphic display memory 18 (step S12).

Based on operation panel information sent from the digital video device 11 corresponding to the selected enlarged operation panel display section 33, the one-chip microcomputer 17 creates an enlarged operation panel display section 33 having operating buttons enlarged in accordance with the enlargement ratio, generating this as graphic data in the graphic display memory 18 (step S13).

The display position of the enlarged operation panel display section 33 is calculated and set into the multi-window control section 13, referring to the display positions and sizes of the enlarged video window display section 30 enlarged by dragging the window display border using the pointer 23, and the other video window displays and graphic displays stored in the nonvolatile flash memory 24 (step S14).

The multi-window control section 13 reads in graphic data from the graphic display memory 18 in synchronization with the refresh timing of the display position and size of the enlarged operation panel display section 33 on the high resolution large screen display device 1, and outputs this to the high resolution large screen display device 1 as a picture signal 8 (step S15).

As a result of the above, enlargement of the enlarged operation panel display section 33 is achieved.

The contracted video window display section 31 and the contracted operation panel display section 34 are rearranged based on the position information stored in the nonvolatile flash memory 24, this being in synchronization with the enlargement processing for the enlarged video window display section 30 and the enlarged operation panel display section 33.

When carrying out the rearrangement, if the amount of enlargement in area of the enlarged video window display section 30 and the enlarged operation panel display section 33 can be accommodated purely by moving the locations of the contracted video window display section 31 and the contracted operation panel display section 34, then only movement of these locations is carried out.

If the amount of enlargement in area of the enlarged video window display section 30 and the enlarged operation panel display section 33 cannot be accommodated purely by moving the locations of the contracted video window display section 31 and the contracted operation panel display section 34, then the display areas of the contracted video window display section 31 and the contracted operation panel display section 34 are contracted.

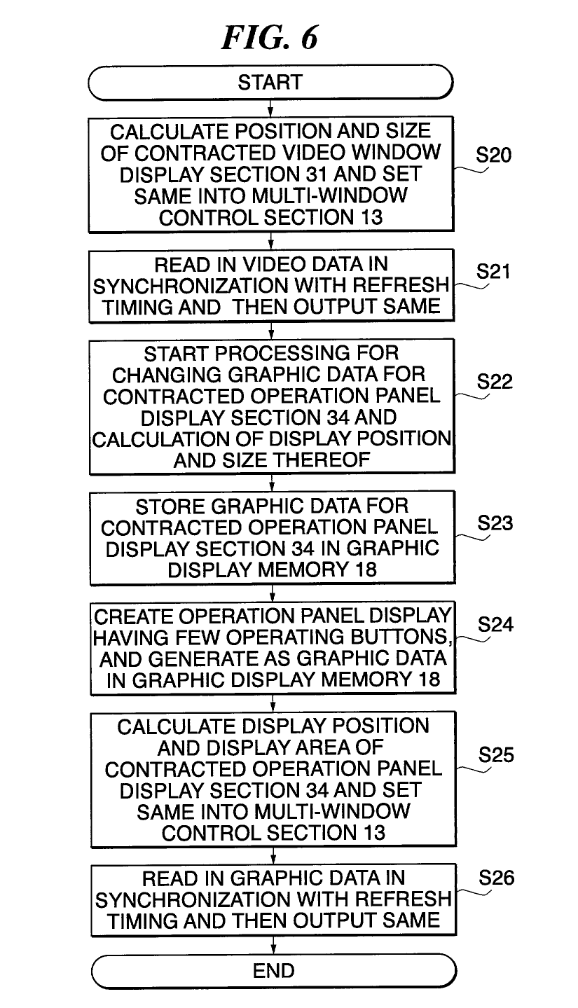

An explanation will now be given, with reference to FIG. 6, of the case in which contraction of the display areas is necessary when the display positions are changed.

Processing in which the contracted video window display section 31 is moved and contracted is carried out so that the contracted video window display section 31 is not made to overlap with the enlarged video window display section 30 due to the enlargement processing of the enlarged video window display section 30.

First, the one-chip microcomputer 17 calculates the position and size of the contracted video window display section 31 from the position information stored in the nonvolatile flash memory 24 and the enlargement instruction information for the enlarged video window display section 30 from the pointer 23, and sets this position and size into the multi-window control section 13 (step S20).

The multi-window control section 13 reads in video data from the video display memories 15 in synchronization with the refresh timing of the display position and size on the high resolution large screen display device 1, and outputs this to the high resolution large screen display device 1 as a picture signal 8 (step S21).

As a result of the above, contraction of the contracted video window display section 31 is achieved.

At the same time, the one-chip microcomputer 17 starts the processing for changing the graphic data for the contracted operation panel display section 34 corresponding to the contracted video window display section 31 and the calculation of the display position and size to be instructed to the multi-window control section 13, this being in synchronization with the contraction processing for the contracted video window display section 31 (step S22).

The image of the contracted operation panel display section 34 is graphic data, and hence this data is stored in the graphic display memory 18 (step S23).

Based on operation panel information sent from the digital video device 11 corresponding to the contracted operation panel display section 34, the one-chip microcomputer 17 creates a more basic operation panel display having few operating buttons, generating this as graphic data in the graphic display memory 18 (step S24).

The display position and display area of the contracted operation panel display section 34 on the high resolution large screen display device 1 are calculated by the one-chip microcomputer 17 as parameters for the multi-window control section 13, and these parameters are set into the multi-window control section 13 (step S25).

The multi-window control section 13 reads in graphic data for the contracted operation panel display section 34 from the graphic display memory 18 in synchronization with the refresh timing of the display position and size of the contracted operation panel display section 34 on the high resolution large screen display device 1, and outputs this graphic data to the high resolution large screen display device 1 as a picture signal 8 (step S26).

As a result of the above, contraction of the contracted operation panel display section 34 is achieved.

When displaying the enlarged operation panel display section 33 at an enlarged size, based on the operation panel information sent from the digital video device 11 corresponding to the enlarged operation panel display section 33, the one-chip microcomputer 17 creates a more detailed operation panel display section with increased operating buttons and operating information, generating this as graphic data in the graphic display memory 18.

When the functions and types of the operating buttons are insufficient for the operation panel information, guidance other than the operating buttons and information such as operation results indicators and operation state reports is created based on the operation panel information, and incorporated into the graphic data in the graphic display memory 18.

Moreover, when displaying the contracted operation panel display section 34 at a contracted size, based on the operation panel information sent from the digital video device 11 corresponding to the contracted operation panel display section 34, the one-chip microcomputer 17 creates a more basic operation panel display section having few operating buttons, generating this as graphic data in the graphic display memory 18.

As described above, according to the present embodiment, the enlarged operation panel display section 33 is enlarged in correspondence with the enlargement of the enlarged video window display section 30, and at the same time easier operation is realized by enlarging the operating buttons, whereas on the other hand the contracted operation panel display section 34 is contracted in correspondence with the contraction of the contracted video window display section 31, and at the same time the number of operating buttons is decreased and more basic or simpler operation is realized.

Note that it is also possible to contract the contracted operation panel display section 34 in correspondence with the contraction of the contracted video window display section 31, and at the same time contract the operating buttons.

(Third embodiment)

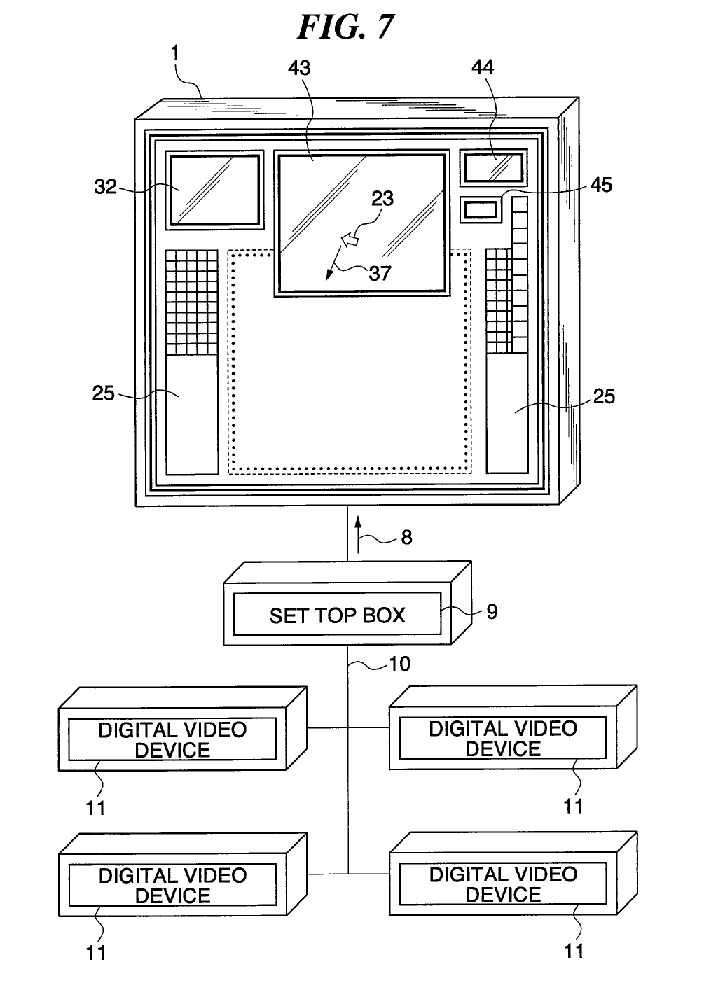

FIG. 7 is a block diagram showing the constitution of a multi-window display system according to a third embodiment of the present invention.

The multi-window display system according to the third embodiment of the present invention is the same as the multi-window display system of the first embodiment, with the exception that the contents displayed on the high resolution large screen display device 1 and the control thereof differ. Corresponding component elements to those in the first embodiment are thus designated by the same reference numerals, and description of these component elements is omitted.

In the present embodiment, the following are displayed on the high resolution large screen display device 1: a subsidiary screen video window display section 43 in which digital video data selected using the pointer 23 is temporarily displayed at an enlarged size and for which a direction of movement is indicated using a short trajectory 37 of the pointer 23, a main screen video window display section 32 that temporarily displays at a contracted size digital video data that was displayed at the maximum display size until the subsidiary screen video window display section 43 received a movement direction instruction, a subsidiary screen video window display section 44 having a display area smaller than the subsidiary screen video window display section 33, and a subsidiary screen video window display section 45 similarly having a display area smaller than the subsidiary screen video window display section 44.

Here, in FIG. 7, the subsidiary screen video window display section 43 is displaying the digital video data selected using the pointer 23 and hence is enlarged. However, the relationship between the subsidiary screen video window display sections 43 to 45 and the main screen video window display section 32 before this selection is made using the pointer 23 is that the more recent the selection using the pointer 23, the larger the video window display section in which the selected digital video data is displayed.

That is, the most recently selected digital video data is displayed in the main screen video window display section 32, the next most recently selected digital video data is displayed in the subsidiary screen video window display section 43, followed by the subsidiary screen video window display section 44, and then the subsidiary screen video window display section 45.

Moreover, the high resolution large screen display device 1 also displays operation panel window display sections 25 in which is integrated the operation system for all of the digital video data from the main screen video window display section 32 and the subsidiary screen video window display sections 43 to 45.

The set top box 9 composes the digital video data for displaying in the main screen video window display section 32 and the subsidiary screen video window display sections 43 to 45, and the operation panel display graphic data for displaying in the operation panel window display sections 25, and then outputs the composed data to the high resolution large screen display device 1 as a picture signal 8.

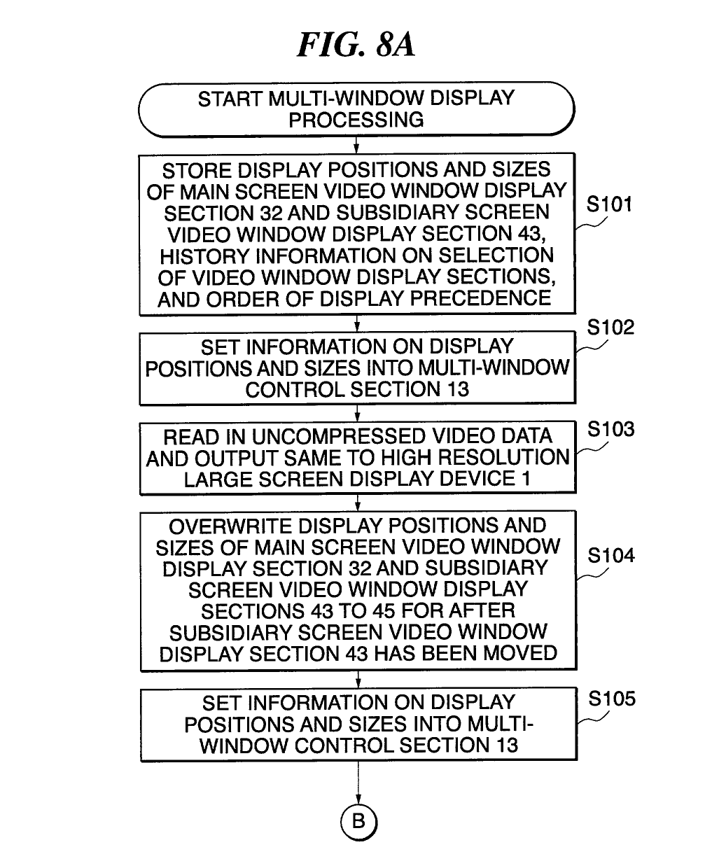

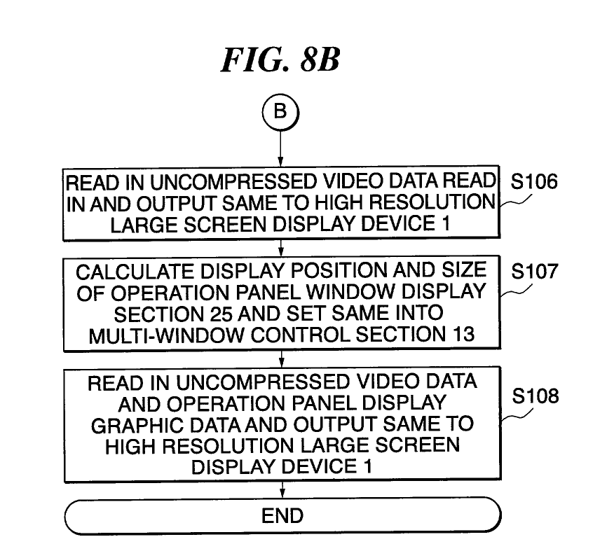

FIGS. 8A and 8B is a flow chart showing the multi-window display processing for the high resolution large screen display device 1.

As an example, an explanation will now be given of the multi-window display processing in the case that the subsidiary screen video window display section 43 has been selected using the pointer 23.

To temporarily display at a suitable enlarged size the subsidiary screen video window display section 43 selected using the pointer 23, and at the same time move the main screen video window display section 32 so as not to overlap with the enlarged subsidiary screen video window display section 43 and display the main screen video window display section 32 at a contracted size, the one-chip microcomputer 17 calculates the display positions and sizes of the main screen video window display section 32 and the subsidiary screen video window display section 43, and stores the calculation results, history information on the selection of the video window display sections and an order of display precedence in the nonvolatile flash memory 24 (step S101). Note that in this case, the subsidiary screen video window display sections 44 and 45 do not overlap with the subsidiary screen video window display section 43, and hence do not need to be displayed at a contracted size. Moreover, history information on the selection of the video window display sections is stored in the nonvolatile flash memory 24 for executing the display at a contracted size of the video window display sections at the respective positions thereof without changing the order of the sizes of the video window display sections. For example, when displaying the subsidiary screen video window display sections 44 and 45 at a contracted size, it is always necessary to display the subsidiary screen video window display section 44 larger than the subsidiary screen video window display section 45. It is thus necessary to store history information on the selection of the video window display sections in the nonvolatile flash memory 24.

Next, the information on the display positions and sizes stored in the nonvolatile flash memory 24 is set into the multi-window control section 13 via the internal system bus 21 (step S102).

The multi-window control section 13 reads in uncompressed video data from the video display memories 15 in synchronization with the refresh timing of the display positions of the window displays on the screen of the high resolution large screen display device 1, and outputs this video data to the high resolution large screen display device 1 as a picture signal 8 (step S103).

After that, referring to all of the display position information stored in the nonvolatile flash memory 24 by means of direction indicating operations for the subsidiary screen video window display section 43 carried out using the pointer 23, the one-chip microcomputer 17 calculates the final display position and size of the subsidiary screen video window display section 43 to be assumed after the subsidiary screen video window display section 43 has been moved in a direction inferred from the trajectory of the pointer 23, and also calculates the display positions and sizes of the main screen video window display section 32 and the subsidiary screen video window display sections 44 and 45, and then overwrites the calculation results into the nonvolatile flash memory 24 (step S104).

The information on these display positions and sizes stored in the nonvolatile flash memory 24 is then set into the multi-window control section 13 via the internal system bus 21 (step S105).

The multi-window control section 13 reads in uncompressed video data from the video display memories 15 in synchronization with the refresh timing of the display positions of the window displays on the screen of the high resolution large screen display device 1, and outputs this video data to the high resolution large screen display device 1 as a picture signal 8 (step S106).

After that, referring to the information on the display positions and sizes of the main screen video window display section 32 and the subsidiary screen video window display sections 43 to 45 stored in the nonvolatile flash memory 24, the one-chip microcomputer 17 calculates the remaining display area of the high resolution large screen display device 1, and sets information on the display position and size of an operation panel window display section 25 that fits into the calculated display area into the multi-window control section 13 via the internal system bus 21 (step S107).

The multi-window control section 13 reads in uncompressed video data from the video display memories 15 and operation panel display graphic data from the graphic display memory 18 in synchronization with the refresh timing of the display positions of the window displays on the screen of the high resolution large screen display device 1, and outputs this data to the high resolution large screen display device 1 as a picture signal 8 (step S108). This completes the present processing.

As a result of the above, the multi-window display system according to the present embodiment achieves multi-window display.

As described above, according to the present embodiment, multi-window display is realized in which the subsidiary screen video window display section 43 selected by the user using the pointer 23 is temporarily displayed at an enlarged size, the final display position and size of the subsidiary screen video window display section 43 after having been moved by means of a direction indicating operation using the pointer 23 is calculated and the display positions and sizes of the main screen video window display section 32 and the subsidiary screen video window display sections 44 and 45 are also calculated, and the display position and size of the operation panel window display section 25 are determined from the remaining display area on the high resolution large screen display device 1. An easy-to-view screen display that continuously reflects the user's wishes can thus be provided. Moreover, the user's volition can be reflected in the determination of the window layout to an extent that operation by the user does not become complicated.

(Fourth embodiment)

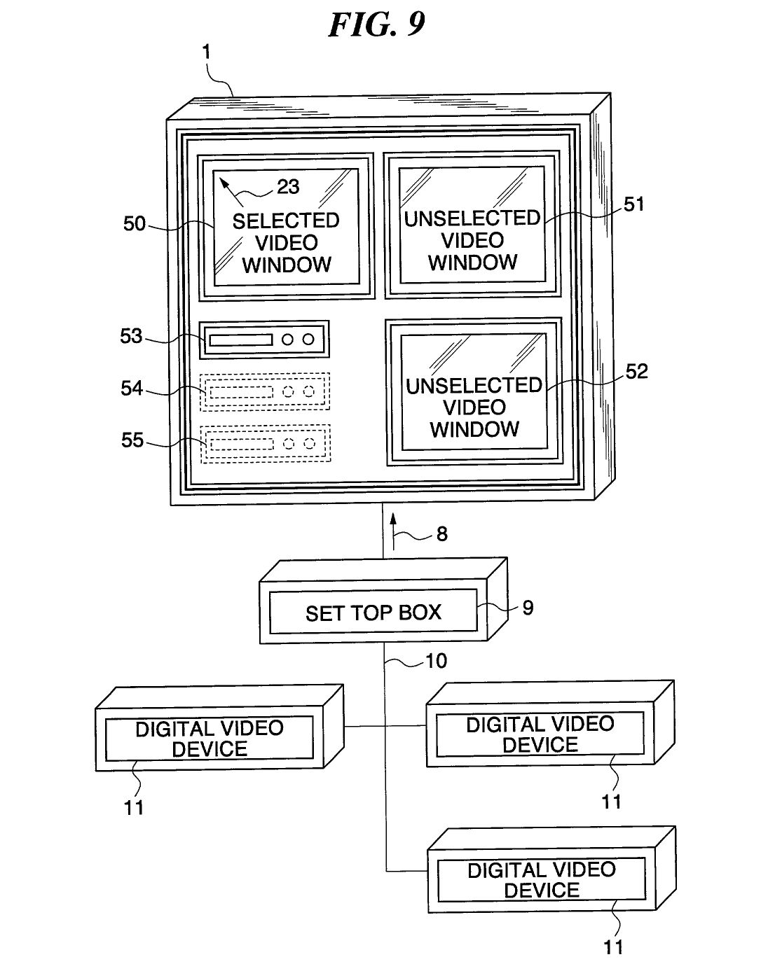

FIG. 9 is a block diagram showing the constitution of a multi-window display system according to a fourth embodiment of the present invention.

The multi-window display system according to the fourth embodiment of the present invention is the same as the multi-window display system of the above-mentioned first embodiment with the exception that the display contents of the high resolution large screen display device 1 differ. Corresponding component elements to those in the first embodiment are thus designated by the same reference numerals, and description of these component elements is omitted.

In FIG. 9, the following are displayed on the high resolution large screen display device 1: a selected video window display section 50 selected using the pointer 23, unselected video window display sections 51 and 52 not selected using the pointer 23, an operation panel window display section 53 displaying an operation panel corresponding to the selected video window display section 50, a non-operation panel window display section 54 semi-transparently displaying an operation panel corresponding to the unselected video window display section 51, and a non-operation panel window display section 55 semi-transparently displaying an operation panel corresponding to the unselected video window display section 52.

Operation panel information necessary for displaying the operation panel window display section 53 and the non-operation panel window display sections 54 and 55 is sent from the digital video devices 11 to the I/O control section 19 of the set top box 9 via the digital serial bus 10, and operation panel display graphic data corresponding to the necessary functions is created in the graphic display memory 18 by the one-chip microcomputer 17.

The compressed digital video data necessary for the selected video window display section 50 and the unselected video window display sections 51 and 52 is sent, like the operation panel information, from the digital video devices 11 to the I/O control section 19 of the set top box 9 via the digital serial bus 10, and is then sent from the I/O control section 19 to the compressed video data decoders 14 via the internal system bus 21 by the one-chip microcomputer 17 of the set top box 9.

The compressed digital video data is temporarily written to the video display memories 15 in a still compressed state, and after expansion processing has been carried out by the compressed video data decoders 14, is then once again written to the video display memories 15, this time as uncompressed digital video data, namely display refresh picture data.

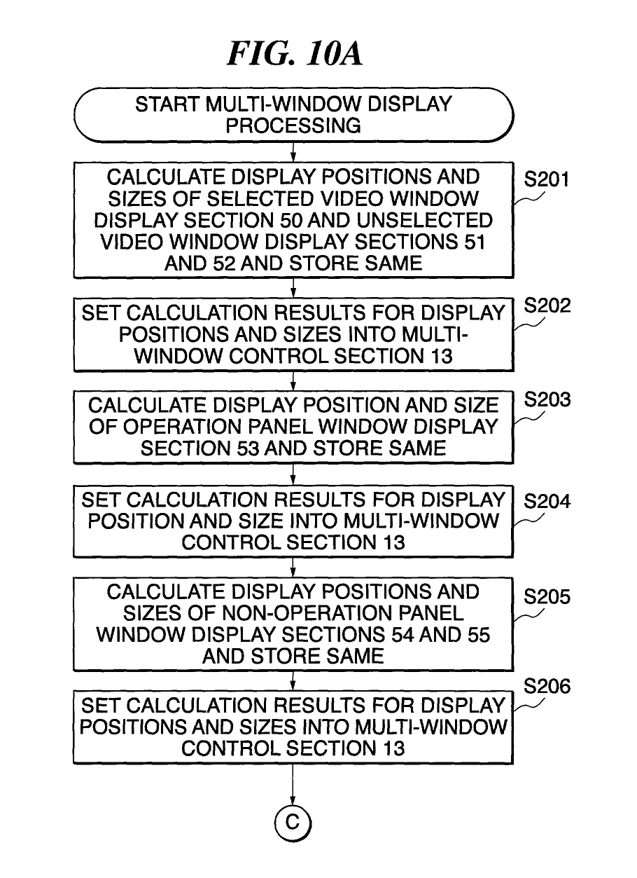

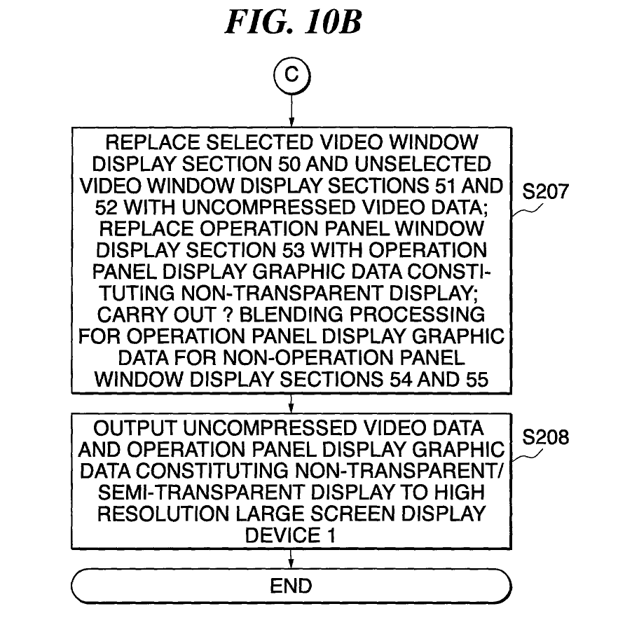

FIGS. 10A and 10B is a flow chart showing the multi-window display processing for the high resolution large screen display device 1 when the selected video window display section 50 has been selected using the pointer 23.

First, the one-chip microcomputer 17 calculates the display positions and sizes of the selected video window display section 50 and the unselected video window display sections 51 and 52 on the screen of the high resolution large screen display device 1, and temporarily stores the calculation results in the nonvolatile flash memory 24 (step S201), and then sets the calculation results stored in the nonvolatile flash memory 24 into the multi-window control section 13 via the internal system bus 21 (step S202).

Next, the one-chip microcomputer 17 calculates the display position and size of the operation panel window display section 53 on the screen of the high resolution large screen display device 1, and temporarily stores the calculation results in the nonvolatile flash memory 24 (step S203), and then sets the calculation results stored in the nonvolatile flash memory 24 into the multi-window control section 13 via the internal system bus 21 (step S204).

Next, the one-chip microcomputer 17 calculates the display positions and sizes of the non-operation panel window display sections 54 and 55 on the screen of the high resolution large screen display device 1, and temporarily stores the calculation results in the nonvolatile flash memory 24 (step S205), and then sets the calculation results stored in the nonvolatile flash memory 24 into the multi-window control section 13 via the internal system bus 21 (step S206).

After that, the multi-window control section 13 reads in uncompressed video data from the video display memories 15 and operation panel display graphic data from the graphic display memory 18 in synchronization with the refresh timing on the screen of the high resolution large screen display device 1, and replaces the portions of the background screen corresponding to the selected video window display section 50 and the unselected video window display sections 51 and 52 with the uncompressed video data for the selected video window display section 50 and the unselected video window display sections 51 and 52, and also replaces the portion of the background screen corresponding to the operation panel window display section 53 with the operation panel display graphic data constituting non-transparent display of the operation panel window display section 53 (step S207).

The non-operation panel window display sections 54 and 55 do not correspond to the selected video window display section 50 selected using the pointer 23, and hence the portions of the background screen corresponding to the non-operation panel window display sections 54 and 55 are not replaced with the operation panel display graphic data constituting non-transparent display of the non-operation panel window display sections 54 and 55, but rather a blending processing that mixes the operation panel display graphic data for non-operation panel window display sections 54 and 55 at a certain proportion into the operation panel display graphic data for [the portions of] the background screen corresponding to the non-operation panel window display sections 54 and 55 is carried out at the same time as step S207.

The uncompressed video data for the selected video window display section 50 and the unselected video window display sections 51 and 52, the operation panel display graphic data constituting non-transparent display of the operation panel window display section 53, and the operation panel display graphic data obtained through a blending processing and constituting semi-transparent display of the non-operation panel window display sections 54 and 55, are then outputted to the high resolution large screen display device 1 as a single picture signal 8 (step S208). This completes the present processing.

Note that when the current unselected video window display section 51 is selected using the pointer 23, the display of the non-operation panel window display section 54 corresponding to the unselected video window display section 51 becomes non-transparent, and the display of the operation panel window display section 53 becomes half-transparent.

As described above, according to the present embodiment, the display of the operation panel window display section 53 corresponding to the selected video window display section 50 selected using the pointer 23 becomes non-transparent, and the display of the non-operation panel window display sections 54 and 55 corresponding to the other video window display sections not selected, namely the unselected video window display sections 51 and 52, becomes semi-transparent. An easy-to-view screen display that continuously reflects the user's wishes can thus be provided. Moreover, the selected screen operation panel can be displayed distinctly.

Note that in the present embodiment, when the selected video window display section 50 is selected using the pointer 23, the display of the corresponding operation panel window display section 53 becomes non-transparent. However, the display of the non-operation panel window display section 54, for example, may also be changed from semi-transparent to non-transparent by selecting the non-operation panel window display section 54 directly using the pointer 23, in which case the unselected video window display section 51 becomes the selected screen.

It is to be understood that the present invention may also be realized by supplying a system or an apparatus with a storage medium in which a program code of software that realizes the functions of any of the above described embodiments is recorded, and causing a computer (or CPU, MPU) of the system or apparatus to read out and execute the program code stored in the storage medium.

In this case, the program code itself read out from the storage medium realizes the functions of any of the above described embodiments, so that the storage medium storing the program code also constitutes the present invention. The storage medium for supplying the program code may be selected, for example, from a floppy disk, hard disk, optical disk, magneto-optical disk, CD-ROM, CD-R, magnetic tape, non-volatile memory card, ROM, or the program code may be obtained by downloading.

The functions of any of the above described embodiments may be accomplished not only by executing a program code read out by a computer, but also by causing an operating system (OS) that operates on the computer, to perform a part or the whole of the actual operation according to instructions of the program code.

Furthermore, it is to be understood that the program code read out from the storage medium may be written into a memory provided in an expanded board inserted in the computer, or an expanded unit connected to the computer, and a CPU, or the like, provided in the expanded board or expanded unit may actually perform a part or the whole of the operations according to the instructions of the program code, so as to accomplish the functions of any of the above described embodiments.

What is claimed is:

1. A multi-window display system comprising:
a plurality of window display sections that each display data;
operation panel window display sections displaying operation panel windows that operate said window display sections;
a selecting section that selects one of said window display sections; and
a control section that is responsive to selection of one of said window display sections by said selecting section, changes sizes of said window display sections based on an order of selection by said selecting section.

2. A multi-window display system as claimed in claim 1, wherein said control section determines display positions and sizes of said vide window display sections and said operation panel display sections such that said selected one of said window display sections does not overlap with any of said window display sections other than said selected one of said window display sections or any of said operation panel window display sections.

3. A multi-window display system as claimed in claim 1, wherein said control section determines a display position and size of said window display sections other than said selected one of said window display sections based on a display position and size of said selected one of said window display sections.

4. A multi-window display system as claimed in claim 1, further comprising a storage device that stores an order of display precedence for and a history of selection of said window display sections.

5. A multi-window display system comprising:
a plurality of window display sections that each display data;
a plurality of operation panel window display sections that display a plurality of operation panel windows having operating buttons for operating said window display sections;
a selecting section that selects one of said window display sections; and
a control section that changes a size of one of said operation panel window display sections corresponding to said selected one of said window display sections in accordance with a changing of a size of said selected one of said window display sections.

6. A multi-window display system as claimed in claim 5, wherein said control section changes sizes of said operating buttons of said operation panel window display sections in accordance with the changing of the size of said selected one of said window display sections.

7. A multi-window display system as claimed in claim 5, wherein said control section changes numbers of said operating buttons of said operation panel window display sections in accordance with the changing of the size of said selected one of said window display sections.

8. A multi-window display system as claimed in claim 5, wherein said control section changes display positions and sizes of all of said window display sections and operation panel window display sections that are being displayed, in accordance with the changing of the size of said selected one of said window display sections.

9. A multi-window display method comprising:
a first display step of displaying a plurality of pieces of data in a plurality of window display sections;
a second display step of displaying operation panel windows for operating said window display sections in operation panel window display sections;
a selection step of selecting one of said window display sections; and
a control step of changing sizes of said window display sections based on an order of selection by said selecting section, in response to selection of one of said window display sections by said selection step.

10. A multi-window display method as claimed in claim 9, wherein said control step comprises determining display positions and sizes of said vide window display sections and said operation panel display sections such that said selected one of said window display sections does not overlap with any of said window display sections other than said selected one of said window display sections or any of said operation panel window display sections.

11. A multi-window display method as claimed in claim 9, wherein said control step comprises determining a display position and size of said window display sections other than said selected one of said window display sections based on a display position and size of said selected one of said window display sections.

12. A multi-window display method as claimed in claim 9, further comprising a storage step of storing an order of display precedence for and a history of selection of said window display sections.

13. A multi-window display method comprising:
a first display step of displaying a plurality of pieces of data in a plurality of window display sections;
a second display step of displaying a plurality of operation panel windows having operating buttons for operating said window display sections in a plurality of operation panel window display sections;
a selection step of selecting one of said window display sections; and
a control step of changing a size of one of said operation panel window display sections corresponding to said selected one of said window display sections in accordance with a changing of a size of said selected one of said window display sections.

14. A multi-window display method as claimed in claim 13, wherein, in said control step, sizes of said operating buttons of said operation panel window display sections are changed in accordance with the changing of the size of said selected one of said window display sections.

15. A multi-window display method as claimed in claim 13, wherein, in said control step, numbers of said operating buttons of said operation panel window display sections are changed in accordance with the changing of the size of said selected one of said window display sections.

16. A multi-window display method as claimed in claim 13, wherein said control step comprises changing display positions and sizes of all of said window display sections and operation panel window display sections that are being displayed, in accordance with the changing of the size of said selected one of said window display sections.

17. A storage medium storing a program that is executable by a computer for implementing a multi-window display method comprising:
a first display step of displaying a plurality of pieces of data in a plurality of window display sections;
a second display step of displaying operation panel windows for operating said window display sections in operation panel window display sections;
a selection step of selecting one of said window display sections; and
a control step of changing sizes of said window display sections based on an order of selection by said selecting section, in response to selection of one of said window display sections by said selection step.

18. A storage medium storing a program that is executable by a computer for implementing a multi-window display method comprising:
a first display step of displaying a plurality of pieces of data in a plurality of window display sections;
a second display step of displaying a plurality of operation panel windows having operating buttons for operating said window display sections in a plurality of operation panel window display sections;
a selection step of selecting one of said window display sections; and
a control step of changing a size of one of said operation panel window display sections corresponding to said selected one of said window display sections in accordance with a changing of a size of said selected one of said window display sections.

19. A multi-window display system comprising:
a plurality of window display sections that each display data;
operation panel window display sections that display operation panel windows for operating said window display sections;
a selecting section that selects one of said window display sections;
a movement direction indicating section that indicates a direction of movement of said one of said window display sections selected by said selecting section; and
a control section that is responsive to indication of the direction of movement of said selected one of said window display sections by said movement direction indicating section, for moving said selected one of said window display sections in the indicated direction of movement and displaying said selected one of said window display sections at an enlarged size.

20. A multi-window display system as claimed in claim 19, wherein, when one of said window display sections has been selected by said selecting section, said control section carries out control such that at least one of said window display sections other than said one of said window display sections selected by said selecting section are displayed so as not to overlap with said one of said window display sections selected by said selecting section.

21. A multi-window display system as claimed in claim 19, wherein, when one of said window display sections has been selected by said selecting section, said control section displays said one of said window display sections selected by said selecting section at an enlarged size.

22. A multi-window display system as claimed in claim 21, wherein, when said one of said window display sections displayed at said enlarged size is moved in said indicated direction of movement, said control section displays said one of said window display sections displayed at said enlarged size at maximum size.

23. A multi-window display system as claimed in claim 21, wherein, when said one of said window display sections displayed at said enlarged size is moved in said indicated direction of movement, said control section displays said operation panel window display sections in a region not occupied by said window display sections.

24. A multi-window display system comprising:
a plurality of window display sections that each display data;
operation panel window display sections that display a plurality of operation panels each corresponding to one of said window display sections;
a selecting section that selects one of said window display sections or one of said operation panel window display sections; and
a control section that is responsive to selection of one of said window display sections by said selecting section, for semi-transparently displaying at least one of said operation panel window display sections corresponding to at least one of said window display sections other than said one of said window display sections selected by said selecting section.

25. A multi-window display system as claimed in claim 24, wherein, when another one of said operation panel window display sections has been selected by said selecting section following selection of said one of said operation panel window display sections, said control section changes display of one of said operation panel window display sections corresponding to said another one of said window display sections from semi-transparent display to non-transparent display.

26. A multi-window display system as claimed in claim 24, wherein, when one of said operation panel window display sections has been selected by said selecting section, said control section displays said selected one of said operation panel window display sections non-transparently.

27. A multi-window display method comprising:
a first display step of displaying a plurality of pieces of data in a plurality of window display sections;
a second display step of displaying operation panel windows for operating said window display sections in operation panel window display sections;
a selecting step of selecting one of said window display sections;
a movement direction indicating step of indicating a direction of movement of said selected one of said window display sections; and
a control step of moving, in response to indication of the direction of movement of said selected one of said window display sections by said movement direction indicating section, said selected one of said window display sections in the indicated direction of movement and displaying said selected one of said window display sections at an enlarged size.

28. A multi-window display method as claimed in claim 27, wherein, when one of said window display sections has been selected in said selecting step, then in said control step, control is carried out such that at least one of said window display sections other than said one of said window display sections selected in said selecting step are displayed so as not to overlap with said one of said window display sections selected in said selecting step.

29. A multi-window display method as claimed in claim 27, wherein, when one of said window display sections has been selected in said selecting step, then in said control step, said one of said window display sections selected in said selecting step is displayed at an enlarged size.

30. A multi-window display method as claimed in claim 29, wherein, when said one of said window display sections displayed at said enlarged size is moved in said indicated direction of movement, then in said control step, said one of said window display sections displayed at said enlarged size is displayed at maximum size.

31. A multi-window display method as claimed in claim 29, wherein, when said one of said window display sections displayed at said enlarged size is moved in said indicated direction of movement, then in said control step, said operation panel window display sections are displayed in a region not occupied by said window display sections.

32. A multi-window display method comprising:
a first display step of displaying a plurality of pieces of data in a plurality of window display sections;
a second display step of displaying a plurality of operation panels each corresponding to one of said window display sections in operation panel window display sections;
a selecting step of selecting one of said window display sections or one of said operation panel window display sections; and
a control step of semi-transparently displaying, in response to selection of one of said window display sections by said selecting step, at least one of said operation panel window display sections corresponding to at least one of said window display sections other than said one of said window display sections selected by said selecting section.

33. A multi-window display method as claimed in claim 32, wherein, when another one of said operation panel window display sections has been selected by said selecting step following selection of said one of said operation panel window display sections, then in said control step, display of one of said operation panel window display sections corresponding to said another one of said window display sections is changed from semi-transparent display to non-transparent display.

34. A multi-window display method as claimed in claim 32, wherein, when one of said operation panel window display sections has been selected, then in said control step, said selected one of said operation panel window display sections is displayed non-transparently.
